(19) United States
(12) Patent Application Publication
(10) Pub. No.: US 2025/0206002 A1
(43) Pub. Date: Jun. 26, 2025

(54) DECORATIVE FILM

(71) Applicant: 3M INNOVATIVE PROPERTIES COMPANY, St. Paul, MN (US)

(72) Inventor: Hidetoshi Abe, Yamagata (JP)

(21) Appl. No.: 18/848,267

(22) PCT Filed: May 23, 2023
(86) PCT No.: PCT/IB2023/055305

§ 371 Date: Sep. 18, 2024

(30) Foreign Application Priority Data
May 27, 2022 (JP) 2022-087050

(51) Int. Cl. B32B 27/08; B32B 7/12; B32B 27/40

(52) U.S. Cl. CPC B32B 27/08; B32B 7/12; B32B 27/40; B32B 2250/02; B32B 2250/03; B32B 2250/24; B32B 2264/1022; B32B 2307/3065; B32B 2307/4026; B32B 2307/412; B32B 2307/54; B32B 2405/00; B32B 2451/00

(57) ABSTRACT

A decorative film including a transparent surface layer, a colored polyurethane layer, and an adhesive layer, wherein the colored polyurethane layer includes a water-based polyether-based polyurethane and a pigment, and the transparent surface layer and the colored polyurethane layer are disposed adjacent to each other. The polyurethane-based decorative film is excellent in strength, shape followability, weather resistance, and dimensional stability and can be colored in various colors.

### TECHNICAL FIELD

The present disclosure relates to a decorative film.

### BACKGROUND ART

A decorative film has been used in various applications, such as signages, signs, marking of a vehicle, illuminated signs, paint protection, or vehicle wrapping, for example. As the decorative film, there is generally known a film including polyvinyl chloride (PVC) film having excellent properties such as strength, shape followability, weather resistance, and dimensional stability. In order to respond to a recent demand of making non-PVC, it has been examined to replace a PVC film constituting the decorative film with a non-PVC-based film, for example, a polyurethane film.

Patent Document 1 (JP 2013-237216 A) describes “a decorative sheet comprising a surface layer and an adhesive layer, with the surface layer being a polyurethane layer obtained by: crosslinking using 0.1 to 2.0 equivalents of a curing agent per acid value of carboxyl groups, and coating and drying of a straight chain polyurethane resin obtained by reaction of a diamine chain extender agent with a polyurethane prepolymer obtained by reaction of a polycarbonate diol having an alicyclic structure, an aliphatic diol having a carboxyl group, and an isocyanate including 4,4′-cyclohexylmethanediisocyanate, wherein the molecular weight of the straight chain polyurethane resin is in the range from about 50000 to about 350000, and the straight chain polyurethane resin exhibits an acid value in the range from about 20.0 to about 30.0 mg·KOH/g”.

Patent Document 2 (JP 2004-149550 A) describes “a functional urethane resin film, having substantially no tackiness, having a tensile breaking elongation (a value measured at −10° C. and a tensile speed of 200 mm/min in a sample having a length of 30 mm, a width of 10 mm, and a thickness of 0.05 mm) of a range from 50 to 1000%, and being formed of an aqueous urethane resin dispersion”.

Patent Document 3 (JP 2010-184361 A) describes “a colored laminated film for an automobile to be attached to a surface of a resin molded body, the colored laminated film comprising a colored coating film layer obtained by kneading one of an acrylic resin and an urethane resin, or a mixture thereof with one of a pigment, a dye, and a colorant, or a mixture thereof, wherein an anchor coat layer having a primer layer or an adhesive layer on a rear surface thereof for enhancing a adhesiveness and protectiveness of the colored coating film layer and the resin molded body is formed on a lower surface side of the colored coating film layer”.

Patent Document 4 (JP 2001-253033 A) describes “a marking film, comprising: a substrate layer including a thermoplastic resin substantially free of halogen and being colored: a pressure sensitive adhesive layer; and a releasing material layer, stacked in this order, wherein a tear strength of the substrate layer measured in accordance with the B method (Elmendorf tear method) of JIS K-7128 is from 0.8 to 3 N.

### SUMMARY OF INVENTION

A polyurethane-based decorative film is required to have a performance equivalent to that of the PVC-based decorative film in terms of strength, shape followability, weather resistance, and dimensional stability. Further, a polyurethane-based decorative film colored in various colors depending on applications is desired.

The present disclosure provides a polyurethane-based decorative film which is excellent in strength, shape followability, weather resistance, and dimensional stability, and can be colored in various colors.

The present inventors have found that a decorative film including a colored polyurethane layer including a particular polyurethane in a specific arrangement can meet all the requirements described above.

According to an embodiment of the present disclosure, there is provided a decorative film including a transparent surface layer, a colored polyurethane layer, and an adhesive layer, wherein the colored polyurethane layer includes a water-based polyether-based polyurethane and a pigment, and the transparent surface layer and the colored polyurethane layer are disposed adjacent to each other.

According to the present disclosure, it is possible to provide a decorative film that is excellent in strength, shape followability, weather resistance, and dimensional stability, and is colored in various colors.

The above description should not be construed as disclosing all embodiments of the present invention and all advantages relating to the present invention.

### BRIEF DESCRIPTION OF DRAWINGS

FIG. 1 is a schematic cross-sectional view of a decorative film of one embodiment.

FIG. 2 is a graph showing a relationship between elongation (%) and tensile strength (N/25 mm) of decorative films of Example 2, Example 9, and Comparative Example 1.

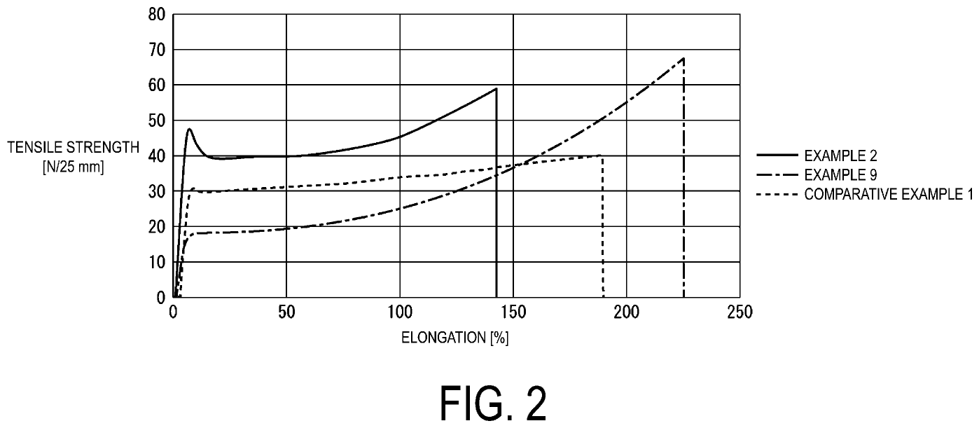

FIG. 3 is a graph showing a relationship between elongation (%) and tensile strength (N/25 mm) of decorative films of Example 17, Comparative Example 3, Comparative Example 4, and Reference Example 1.

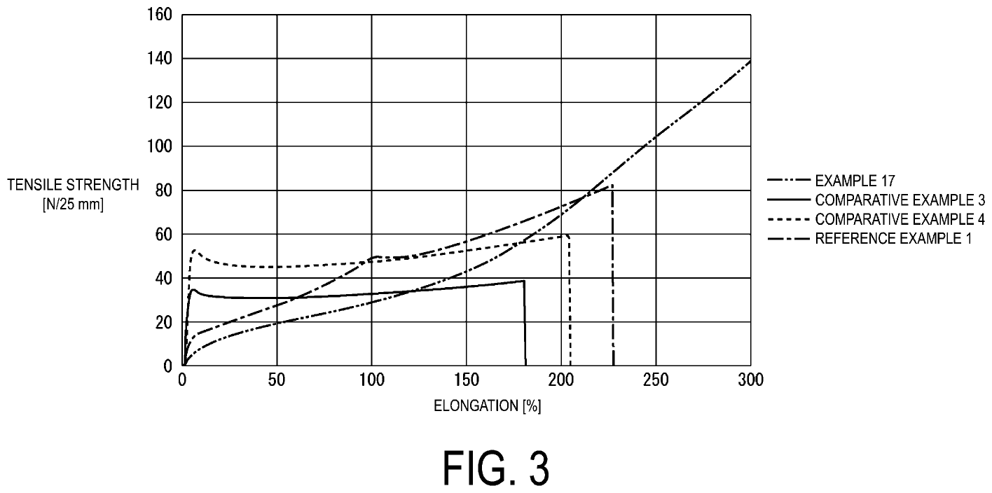

### DESCRIPTION OF EMBODIMENTS

Hereinafter, representative embodiments of the present invention will be described in more detail with reference to the drawing, as necessary, for the purpose of illustration, but the present invention is not limited to these embodiments.

In the present disclosure, the term “film” encompasses articles referred to as “sheets”.

In the present disclosure, the term “(meth)acrylic” refers to acrylic or methacrylic, and the term “(meth)acrylate” refers to acrylate or methacrylate.

In the present disclosure, “pressure-sensitive adhesion” refers to the characteristic of a material or composition that is permanently adhesive in the temperature range of usage, such as from 0° C. to 50° C., and that adheres to various surfaces with light pressure for a short time and does not exhibit a phase change (from liquid to solid).

In the present disclosure, the term “transparent” refers to an average transmittance of approximately 80% or greater, preferably approximately 85% or greater or approximately 90% or greater, in the visible light range (wavelengths from 400 nm to 700 nm), measured in accordance with JIS K 7375:2008. An upper limit of the average transmittance is not particularly limited, and can be, for example, approximately less than 100%, approximately 99% or less, or approximately 98% or less.

In the present disclosure, the term “translucent” refers to an average transmittance of approximately 40% or greater and less than approximately 80%, preferably approximately 75% or less, in the visible light range (wavelengths from 400 nm to 700 nm), measured in accordance with JIS K 7375:2008.

In the present disclosure, the term “opaque” refers to a material or composition being neither transparent nor translucent.

In the present disclosure “non-PVC-based” means that a decorative film is substantially free of polyvinyl chloride, for example, a polyvinyl chloride film or a polyvinyl chloride layer. In an embodiment, a content of polyvinyl chloride of a decorative film is about 1 mass % or less, about 0.5 mass % or less, or about 0.1 mass % or less.

A decorative film of an embodiment includes a transparent surface layer, a colored polyurethane layer, and an adhesive layer. The colored polyurethane layer includes a water-based polyether-based polyurethane and a pigment. The transparent surface layer and the colored polyurethane layer are disposed adjacent to each other. When another layer such as a transparent adhesive layer is interposed between the transparent surface layer and the colored polyurethane layer, light incident on the decorative film may be internally reflected due to a refractive index difference between the material of the interposing layer and the material of the transparent surface layer or the colored polyurethane layer. Such internal reflection of incident light may facilitate deterioration of the interposing layer. In the decorative film of this embodiment, the transparent surface layer and the colored polyurethane layer are disposed adjacent to each other, and thus internal reflection of incident light due to the presence of the interposing layer does not occur. Accordingly, the decorative film of this embodiment has excellent weather resistance.

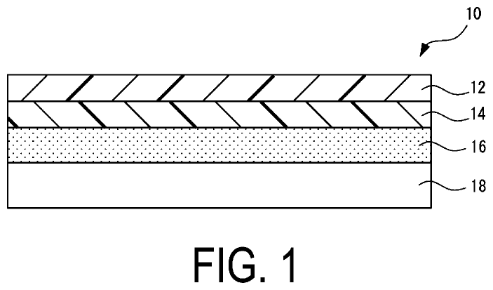

FIG. 1 illustrates a schematic cross-sectional view of a decorative film of an embodiment. A decorative film 10 includes a transparent surface layer 12, a colored polyurethane layer 14, and an adhesive layer 16. The transparent surface layer 12 and the colored polyurethane layer 14 are disposed adjacent to each other. The decorative film 10 may further include a release liner 18 as an optional element.

Various resin films can be used as the transparent surface layer. The transparent surface layer is preferably stretchable. As the transparent surface layer, at least one resin film selected from the group consisting of polyurethane, polyethylene, polypropylene, an acrylic resin, a cellulose resin, and a fluororesin can be used.

From the perspective of strength, shape followability, weather resistance, and dimensional stability, the transparent surface layer preferably includes polyurethane.

In one embodiment, the polyurethane contained in the transparent surface layer is a polyurethane having a polycarbonate backbone (hereinafter, also referred to as “polycarbonate-based polyurethane”). The polycarbonate-based polyurethane is relatively hard and rigid, and thus it is possible to suppress damage to the surface of the decorative film and impart a strength and chemical resistance to the decorative film. In addition, the polycarbonate-based polyurethane has excellent weather resistance and water resistance, and thus it is possible to make the decorative film capable of withstanding use in an exterior wall of a building, an exterior of a vehicle, a kitchen, a lavatory, a bathroom, or the like.

The polycarbonate-based polyurethane has a structural unit derived from polycarbonate polyol and a structural unit derived from polyisocyanate. The polycarbonate-based polyurethane can be obtained by reaction between polycarbonate polyol and polyisocyanate using a known method.

The polycarbonate polyol is a compound that has a plurality of carbonate groups (—O—C(═O)—O—) in the main chain and has a plurality of hydroxy groups, and can be obtained by reaction between a polyol and a carbonate compound using a known method.

Examples of the polyol include: aliphatic diols such as ethylene glycol, 1,3-propanediol, 1,4-butanediol, 1,5-pentanediol, 3-methyl-1,5-pentanediol, 1,6-hexanediol, and neopentyl glycol; aliphatic triols such as glycerin; and alicyclic diols such as 1,4-cyclohexanedimethanol. The polyol can be used alone, or in combination of two or more types thereof.

Examples of the carbonate compound include dimethyl carbonate, ethylene carbonate, and diphenyl carbonate.

In an embodiment, the polycarbonate polyol is polycarbonate diol having a hydroxyl group at both ends of the carbonate main chain.

Examples of the polyisocyanate include: aliphatic diisocyanates such as hexamethylene diisocyanate, 2,2,4-trimethylhexamethylene diisocyanate, 2,4,4-trimethylhexamethylene diisocyanate, and lysine diisocyanate; alicyclic diisocyanates such as 4,4′-dicyclohexylmethane diisocyanate, isophorone diisocyanate, trans- and/or cis-1,4-cyclohexane diisocyanate, norbornene diisocyanate, and hydrogenated diphenylmethane diisocyanate: aromatic diisocyanates such as diphenylmethane diisocyanate and toluene diisocyanate; and biuret products, isocyanurate products, and adduct products of these. The polyisocyanate may be used alone or in combination of two or more types thereof. The polyisocyanate may be blocked isocyanate blocked by a blocking agent.

From the perspective of weather resistance of the decorative film, the polyisocyanate is preferably a non-yellowing aliphatic diisocyanate or an alicyclic diisocyanate, and more preferably an alicyclic diisocyanate capable of forming a transparent surface layer having a high strength.

The polycarbonate-based polyurethane may further include a structural unit derived from another polyol other than polycarbonate polyol. A content of the structural unit derived from the other polyol can be about 30 mass % or less, about 20 mass % or less, or about 10 mass % or less of the polycarbonate-based polyurethane. In an embodiment, the polycarbonate-based polyurethane does not include a structural unit derived from the other polyol.

Examples of the other polyol include: low molecular weight polyols having 2 to 20 carbon atoms such as ethylene glycol, 1,2-propane diol, 1,3-propane diol, 2-methyl-1,3-propane diol, 2-butyl-2-ethyl-1,3-propane diol, 1,4-butane diol, 1,6-hexane diol, and glycerin: (meth)acrylic polyols that are copolymers of hydroxyl-free (meth)acrylates such as methyl (meth)acrylate, n-butyl (meth)acrylate, 2-ethylhexyl (meth)acrylate, and ethylene glycol (meth)acrylic acid diester with hydroxyl group-containing (meth)acrylates such as 2-hydroxyethyl (meth)acrylate and ethylene glycol methacrylic acid monoester; polyester polyols such as polycaprolactone diol and polycaprolactone triol; and polyether polyols such as polyethylene glycol, polypropylene glycol, polytetramethylene glycol, propylene oxide adducts thereof, propylene oxide adducts of glycerin, propylene oxide adducts of saccharides such as sorbitol and sucrose, and propylene oxide adducts of compounds having active hydrogen such as ethylenediamine. The other polyol can be used alone, or in combination of two or more types thereof.

The transparent surface layer can be formed by applying a reactive polyurethane composition including polycarbonate polyol, polyisocyanate, and another optional polyol, or a polyurethane resin composition including polycarbonate-based polyurethane and an organic solvent or water onto the support film using, for example, knife coating, bar coating, blade coating, doctor coating, roll coating, cast coating, or the like, and heating or drying the composition as necessary. In the reactive polyurethane composition, the polycarbonate polyol, the polyisocyanate, and the optional other polyol react upon heating or drying to generate polycarbonate-based polyurethane in situ.

An equivalence ratio of the polyisocyanate to a total of the polycarbonate polyol and the other polyol in the polycarbonate-based polyurethane included in the reactive polyurethane composition or the polyurethane resin composition can be about 0.7 equivalents or greater, or about 0.9 equivalents or greater, but about 2 equivalents or less, or about 1.2 equivalents or less relative to 1 equivalent of the total of the polycarbonate polyol and the other polyol.

The reactive polyurethane composition may contain a catalyst. As the catalyst, a catalyst that is typically used in formation of a polyurethane resin, such as di-n-butyltin dilaurate, zinc naphthenate, zinc octenoate, or triethylenediamine, can be used. An amount of the catalyst used is typically about 0.005 parts by mass or greater, or about 0.01 parts by mass or greater, but about 0.5 parts by mass or less, or about 0.2 parts by mass or less, per 100 parts by mass of the reactive polyurethane composition.

The reactive polyurethane composition and the polyurethane resin composition may include, for example, an organic solvent for improving workability and coatability. Examples of the organic solvent include: ketones such as methyl ethyl ketone, methyl isobutyl ketone, and acetyl acetone: aromatic hydrocarbons such as toluene and xylene; alcohols such as ethanol and isopropyl alcohol: esters such as ethyl acetate and butyl acetate; and ethers such as tetrahydrofuran, propylene glycol monomethyl ether, propylene glycol monomethyl ether acetate, and dipropylene glycol monomethyl ether acetate. An amount of the organic solvent used is typically about 1 part by mass or greater, or about 5 parts by mass or greater, but about 90 parts by mass or less, or about 80 parts by mass or less, per 100 parts by mass of the composition.

The polyurethane resin composition may be a water-based polyurethane resin composition containing water as a solvent. Water-based polycarbonate-based polyurethane included in the water-based polyurethane resin composition may include a chain extender such as a diamine compound as a structural unit, or may have an anionic group such as a carboxy group or a sulfonic acid group.

The polycarbonate-based polyurethane is preferably the water-based polycarbonate-based polyurethane. By using the water-based polycarbonate-based polyurethane, it is possible to reduce an amount of the organic solvent used in the production of the decorative film. The water-based polycarbonate-based polyurethane has a relatively low affinity for an organic solvent or a low molecular weight organic compound, and thus it is possible to further increase the chemical resistance of the transparent surface layer.

In an embodiment, the polycarbonate-based polyurethane has an alicyclic structure. As an example of the polycarbonate-based polyurethane having an alicyclic structure, there is exemplified a product obtained by further crosslinking, with a crosslinking agent, a linear polyurethane resin obtained by reacting a polyurethane prepolymer and a diamine chain extender, the polyurethane prepolymer being obtained by reacting polycarbonate diol having an alicyclic structure, an aliphatic diol including a carboxy group, and a polyisocyanate component including 4,4′-dicyclohexylmethane diisocyanate.

Examples of the polycarbonate diol having an alicyclic structure include polycarbonate diol synthesized from 1,4-cyclohexanedimethanol and 1,6-hexane diol.

Examples of the aliphatic diol including a carboxy group include 2,2-dimethylolpropionic acid, 2,2-dimethylolbutanoic acid, and 3,3-dimethylolpropionic acid.

An amount of 4,4′-dicyclohexylmethane diisocyanate included in the polyisocyanate component is not particularly limited, but can be, for example, about 30 mass % or greater, or about 50 mass % or greater of the polyisocyanate component.

The polyurethane prepolymer can be obtained by reacting the polycarbonate diol having an alicyclic structure, the aliphatic diol having a carboxy group, and the polyisocyanate component including 4,4′-dicyclohexylmethane diisocyanate using a known method.

The linear polyurethane resin can be obtained by reacting the polyurethane prepolymer with the diamine chain extender. Examples of the diamine chain extender include diamine compounds such as ethylenediamine, propylene diamine, and putrescine.

As the crosslinking agent, a known crosslinking agent that reacts with a carboxy group contained in the linear polyurethane resin can be used, and examples thereof include a polycarbodiimide compound, an aziridine compound, and an oxazoline compound.

A weight average molecular weight of the polycarbonate-based polyurethane is generally about 30000 or greater, about 50000 or greater, or about 80000 or greater, but about 300000 or less, about 200000 or less, or about 150000 or less. In the present disclosure, the weight average molecular weight of the polyurethane is a molecular weight determined by gel permeation chromatography (GPC) using tetrahydrofuran (THF) or N-methylpyrrolidone (NMP) as the solvent, and using standard polystyrene (if the solvent is THF) or standard polymethyl methacrylate (if the solvent is NMP).

In an embodiment, the transparent surface layer includes the polycarbonate-based polyurethane of about 50 mass % or greater, about 60 mass % or greater, or about 70 mass %, but 100 mass % or less, about 95 mass % or less, or about 90 mass % or less. The resin component of the transparent surface layer is preferably composed of the polycarbonate-based polyurethane.

As another optional component, the transparent surface layer may contain an additive such as a UV absorbent, a light stabilizer, a thermal stabilizer, dispersant, a plasticizer, a flow enhancing agent, or a leveling agent.

In an embodiment, the polyurethane contained in the transparent surface layer is a non-yellowing thermoplastic polyurethane elastomer. The non-yellowing thermoplastic polyurethane elastomer can impart high strength, weather resistance, and durability to the decorative film. The 100% elastic modulus (storage elastic modulus at 100% elongation) of the non-yellowing thermoplastic polyurethane elastomer can be, for example, about 100 MPa or greater, or about 250 MPa or greater, but about 2000 MPa or less, or about 1500 MPa or less at 20° C.

The transparent surface layer may be colored or colorless. The transparent surface layer may include a substantially smooth surface or may include a structured surface that can be formed by surface processing such as embossing. Appearance or a shape of the transparent surface layer is as described above, which can impart various decorative characteristics to the decorative film.

In an embodiment, the transparent surface layer includes no pigment. In this embodiment, it is possible to eliminate surface roughness of the transparent surface layer due to presence of the pigment to further improve aesthetics of the decorative film.

The thickness of the transparent surface layer is not particularly limited and, for example, can be about 5 μm or greater, about 10 μm or greater, or about 25 μm or greater, but about 500 μm or less, about 200 μm or less, or about 100 μm or less. By setting the thickness of the transparent surface layer to about 5 μm or greater, it is possible to impart weather resistance and chemical resistance to the decorative film. By setting the thickness of the transparent surface layer to about 500 μm or less, it is possible to impart shape followability to the decorative film.

In an embodiment, total light transmittance of the transparent surface layer in the wavelength range from 400 to 700 nm is about 85% or greater, about 90% or greater, or about 95% or greater.

The colored polyurethane layer includes a water-based polyether-based polyurethane and a pigment, and is disposed adjacent to the transparent surface layer. The water-based polyether-based polyurethane is relatively highly polar, and thus has a high affinity for various pigments, which makes it possible to form a colored polyurethane layer of various colors in which the pigments are uniformly dispersed. The water-based polyether-based polyurethane may also have a high affinity for other components such as a dispersant and a binder resin that may be included in a pigment composition used to form the colored polyurethane layer. In this case, it is possible to suppress or prevent separation of the other components such as a dispersant and a binder resin in the colored polyurethane layer or leaching out of the other components from the colored polyurethane layer. Further, by using the water-based polyether-based polyurethane for forming the colored polyurethane layer, it is possible to reduce an amount of an organic solvent used in the production of the decorative film.

The water-based polyether-based polyurethane has a structural unit derived from polyalkylene glycol and a structural unit derived from polyisocyanate. The water-based polyether-based polyurethane can be obtained by reacting polyalkylene glycol and polyisocyanate using a known method.

Examples of the polyalkylene glycol include polyethylene glycol, polypropylene glycol, polytetramethylene glycol, and polyhexamethylene glycol.

As the polyisocyanate, the polyisocyanate described for the polycarbonate-based polyurethane contained in the transparent surface layer in the embodiment can be used. From the perspective of weather resistance of the decorative film, the polyisocyanate is preferably a non-yellowing aliphatic diisocyanate or alicyclic diisocyanate, and more preferably an aliphatic diisocyanate capable of forming a colored polyurethane layer having excellent pigment dispersibility.

The water-based polyether-based polyurethane may further include a structural unit derived from another polyol other than polyalkylene glycol. A content of the structural unit derived from the other polyol can be about 30 mass % or less, about 20 mass % or less, or about 10 mass % or less of the water-based polyether-based polyurethane. In an embodiment, the water-based polyether-based polyurethane does not include a structural unit derived from the other polyol.

Examples of the other polyol include: low molecular weight polyols having 2 to 20 carbon atoms such as ethylene glycol, 1,2-propane diol, 1,3-propane diol, 2-methyl-1,3-propane diol, 2-butyl-2-ethyl-1,3-propanediol, 1,4-butane diol, 1,6-hexane diol, and glycerin; (meth)acrylic polyols that are copolymers of hydroxyl-free (meth)acrylates such as methyl (meth)acrylate, n-butyl (meth)acrylate, 2-ethylhexyl (meth)acrylate, and ethylene glycol (meth)acrylic acid diester with hydroxyl group-containing (meth)acrylates such as 2-hydroxyethyl (meth)acrylate and ethylene glycol methacrylic acid monoester: polyester polyols such as polycaprolactone diol and polycaprolactone triol; and propylene oxide adducts of polyalkylene glycol such as polypropylene glycol and polytetramethylene glycol, propylene oxide adducts of glycerin, propylene oxide adducts of saccharides such as sorbitol and sucrose, and propylene oxide adducts of compounds having active hydrogen such as ethylenediamine. The other polyol can be used alone, or in combination of two or more types thereof.

Examples of the pigment include organic pigments and inorganic pigments. Examples of the organic pigments include phthalocyanine-based pigments such as phthalocyanine blue and phthalocyanine green, azo lake-based pigments, indigo-based pigments, perinone-based pigments, perylene-based pigments, quinophthalone-based pigments, dioxazine-based pigments, and quinacridone-based pigments such as quinacridone red. Examples of the inorganic pigments include titanium oxide, yellow lead, yellow iron oxide, colcothar, red iron oxide, and carbon black.

In an embodiment, the pigment included in the colored polyurethane layer includes titanium oxide. The colored polyurethane layer including titanium oxide as the pigment can impart concealment with respect to an underlying layer to the decorative film. The content of titanium oxide in the colored polyurethane layer can be about 1 mass % or greater, about 3 mass %, or about 5 mass % or greater, but about 60 mass % or less, about 50 mass % or less, or about 40 mass % or less.

The colored polyurethane layer can be produced by a method similar to that described for the transparent surface layer. Specifically, the colored polyurethane layer can be formed by applying a reactive polyurethane composition including polyalkylene glycol, polyisocyanate, another optional polyol, a pigment, and a water-based solvent, or a polyurethane resin composition including a water-based polyether-based polyurethane, a pigment, and a water-based solvent onto the transparent surface layer using, for example, knife coating, bar coating, blade coating, doctor coating, roll coating, cast coating, or the like, and heating or drying the composition as necessary.

In a water-based polyether-based polyurethane formed from the reactive polyurethane composition or included in the polyurethane resin composition, for an equivalence ratio of the polyisocyanate to the total of the polyalkylene glycol and the other polyol, the polyisocyanate can be about 0.7 equivalents or greater, or about 0.9 equivalents or greater, but about 2 equivalents or less, or about 1.2 equivalents or less relative to 1 equivalent of the total of the polyalkylene glycol and the other polyol.

As a catalyst for the reactive polyurethane composition and an organic solvent that may be included in the reactive polyurethane composition and the polyurethane resin composition, those described for the transparent surface layer can be used.

The polyurethane resin composition is a water-based polyurethane resin composition containing water as a solvent. The water-based polyether-based polyurethane included in the water-based polyurethane resin composition may include a chain extender such as a diamine compound as a structural unit, or may have an anionic group such as a carboxy group or a sulfonic acid group.

The water-based polyether-based polyurethane may be crosslinked by a crosslinking agent. As the crosslinking agent, a known crosslinking agent that reacts with a carboxy group or the like can be used, and examples thereof include a polycarbodiimide compound, an aziridine compound, and an oxazoline compound.

The weight average molecular weight of the water-based polyether-based polyurethane is generally about 30000 or greater, about 50000 or greater, or about 80000 or greater, but about 300000 or less, about 200,000 or less, or about 150000 or less.

In an embodiment, the colored polyurethane layer includes the water-based polyether-based polyurethane of about 50 mass % or greater, about 60 mass % or greater, or about 70 mass % or greater, but 99 mass % or less, about 95 mass % or less, or about 90 mass % or less.

In an embodiment, the colored polyurethane layer includes the pigment of about 1% by mass or greater, about 2% by mass or greater, or about 5% by mass or greater, but about 50% by mass or less, about 40% by mass or less, or about 30% by mass or less.

The colored polyurethane layer may further include another resin such as a water-based polyester-based polyurethane or a polyacrylate. In an embodiment, the colored polyurethane layer further has a water-based polyester-based polyurethane and a polyacrylate. The water-based polyester-based polyurethane and the polyacrylate can increase cohesive force of the colored polyurethane layer to increase its strength.

The total content of the water-based polyester-based polyurethane and the polyacrylate in the colored polyurethane layer can be about 1 mass % or greater, about 2 mass % or greater, or about 5 mass % or greater, but about 20 mass % or less, about 18 mass % or less, or about 15 mass % or less.

In an embodiment, the colored polyurethane layer is free of polycarbonate-based polyurethane.

As another optional component, the colored polyurethane layer may contain an additive such as a UV absorbent, a light stabilizer, a thermal stabilizer, a dispersant, a binder resin, a plasticizer, a flow enhancing agent, or a leveling agent.

The thickness of the colored polyurethane layer is not particularly limited, but can be appropriately determined depending on a printing method, ink, and an applying method used. The thickness of the colored polyurethane layer can be, for example, about 1 μm or greater, or about 5 μm or greater, but about 100 μm or less, or about 50 μm or less.

The total thickness of the transparent surface layer and the colored polyurethane layer can be about 10 μm or greater, or about 20 μm or greater, but about 240 μm or less, or about 200 μm or less. By setting the total thickness of the transparent surface layer and the colored polyurethane layer to the range described above, it is possible to lower an environmental load due to disposal after use without impairing non-flammability or flame retardancy of an adherend to which the decorative film is applied.

The adhesive layer can be formed using a generally used acrylic, polyolefin-based, polyurethane-based, polyester-based, or rubber-based adhesive. The adhesive included in the adhesive layer may be crosslinked with a crosslinking agent. In an embodiment, the adhesive layer is a pressure-sensitive adhesive layer.

The adhesive layer is preferably an acrylic adhesive layer including an acrylic adhesive. The acrylic adhesive layer has excellent durability, weather resistance, and adhesive force. The acrylic adhesive may be crosslinked with a crosslinking agent such as a bisamide crosslinking agent, an aziridine crosslinking agent, a carbodiimide crosslinking agent, an epoxy crosslinking agent, or an isocyanate crosslinking agent.

In an embodiment, the adhesive layer includes a white colorant. By making the adhesive layer white, it is possible to conceal a color of an underlying layer to which the decorative film is applied. Examples of the white colorant include white pigments such as titanium oxide, zinc carbonate, zinc oxide, and zinc sulfide.

In an embodiment, the adhesive layer contains a carboxy group-containing (meth)acrylic polymer, an amino group-containing (meth)acrylic polymer, and 5 mass % to 50 mass % of titanium oxide. The carboxy group-containing (meth)acrylic polymer and the amino group-containing (meth)acrylic polymer can cause a higher amount of titanium oxide to be stably dispersed in the adhesive layer to increase the concealability of the adhesive layer, and at the same time, can suppress reduction in cohesion force of the adhesive layer due to dispersion of titanium oxide to maintain the adhesion property. The carboxy group-containing (meth)acrylic polymer and/or the amino group-containing (meth)acrylic polymer may be crosslinked with the above-described crosslinking agent.

The thickness of the adhesive layer can be about 1 μm or greater, about 5 μm or greater, or about 10 μm or greater, but about 200 μm or less, about 120 μm or less, or about 80 μm or less.

The adhesive layer may be protected by a release liner. Examples of the release liner include: paper having a surface subjected to releasing treatment using a silicone releasing agent or the like: a film including a plastic material such as polyethylene, polypropylene, polyester, or cellulose acetate; and laminate paper coated with such a plastic material.

The thickness of the release liner can be about 5 μm or greater, about 15 μm or greater, or about 25 μm or greater, but about 300 μm or less, about 200 μm or less, or about 150 μm or less.

The decorative film can be produced, for example, by forming the colored polyurethane layer on the transparent surface layer, and forming or transferring the adhesive layer on the colored polyurethane layer. The decorative film can also be produced by forming the transparent surface layer on a support film, forming the colored polyurethane layer on the transparent surface layer, forming or transferring the adhesive layer on the colored polyurethane layer, and removing the support film. After forming the adhesive layer on the colored polyurethane layer, the release liner that protects the adhesive layer may be disposed on the adhesive layer. An adhesive film including the adhesive layer and the release liner may be used to transfer the adhesive layer onto the colored polyurethane layer, thereby producing the decorative film in a state of having the release liner.

As the support film, for example, a resin film including a polyester such as polyethylene terephthalate, a polyolefin such as polyethylene or polypropylene, an acrylic polymer, a urethane-based polymer, or a fluorinated polymer can be used.

A thickness of the support film can be appropriately selected in accordance with a production condition and a use mode of the decorative film. A thickness of the support film may be, for example, about 5 μm or greater or about 10 μm or greater, but about 500 μm or less or about 300 μm or less.

The thickness of the decorative film can be about 30 μm or greater, about 50 μm or greater, or about 70 μm or greater, but about 1 mm or less, about 500 μm or less, or about 300 μm or less. The thickness of the decorative film does not include the thickness of the release liner.

In an embodiment, the decorative film includes the transparent surface layer, the colored polyurethane layer, and the adhesive layer, and has a thickness of about 50 μm or greater and about 250 μm or less. A thin decorative film having such a simple laminate structure has low combustion heat, and has a low amount of the organic material used. Thus, it is possible to lower the environmental load due to disposal after use without impairing non-flammability or flame retardancy of an adherend to which the decorative film is applied.

In an embodiment, the decorative film has a non-PVC-based decorative film.

The decorative film may be transparent, translucent, or opaque. A transparent or translucent decorative film can be used for an internally illuminated signage.

In an embodiment, the yield strength of the decorative film is about 5 N/25 mm or greater, about 8 N/25 mm or greater, or about 10 N/25 mm or greater, but about 200 N/25 mm or less, about 150 N/25 mm or less, or about 100 N/25 mm or less. The yield strength of the decorative film is determined by a method described in the examples.

In an embodiment, the breaking strength of the decorative film is about 5 N/25 mm or greater, about 8 N/25 mm or greater, or about 10 N/25 mm or greater, but about 200 N/25 mm or less, about 150 N/25 mm or less, or about 100 N/25 mm or less. The breaking strength of the decorative film is determined by a method described in the examples.

In an embodiment, the decorative film has an elongation of about 30% or greater, about 50% or greater, or about 70% or greater, but about 300% or less, about 250% or less, or about 230% or less. In another embodiment, the decorative film has an elongation of about 120% or greater, about 150% or greater, or about 200% or greater, but about 800% or less, about 600% or less, or about 400% or less. The elongation of the decorative film is determined by a method described in the examples.

In an embodiment, the tensile strength at 2% strain of the decorative film is about 2 N/25 mm or greater, about 4 N/25 mm or greater, or about 7 N/25 mm or greater, but about 50 N/25 mm or less, about 40 N/25 mm or less, or about 30 N/25 mm or less. In another embodiment, the tensile strength at 2% strain of the decorative film is about 0.5 N/25 mm or greater, about 1 N/25 mm or greater, or about 2 N/25 mm or greater, but about 20 N/25 mm or less, about 15 N/25 mm or less, or about 10 N/25 mm or less. The tensile strength at 2% strain of the decorative film is determined by a method described in the examples.

In an embodiment in which the polyurethane contained in the transparent surface layer is a polycarbonate-based polyurethane, the tensile strength at 2% strain of the decorative film may be about 2 N/25 mm or greater, about 4 N/25 mm or greater, or about 7 N/25 mm or greater, and the elongation may be about 30% or greater, about 50% or greater, or about 70% or greater.

In an embodiment in which the polyurethane contained in the transparent surface layer is a non-yellowing thermoplastic polyurethane elastomer, the tensile strength at 2% strain of the decorative film may be about 20 N/25 mm or less, about 15 N/25 mm or less, or about 10 N/25 mm or less, and the elongation may be about 120% or greater, about 150% or greater, or about 200% or greater.

In the decorative film of an embodiment, the total heat release for 20 minutes after start of heating as measured in accordance with the ISO 5660-1 Heat Release Rate (cone calorimeter method) is about 8 MJ/m² or less, about 7.8 MJ/m² or less, or about 7.5 MJ/m² or less.

In an embodiment, for a decorative film that can be used for glass scattering prevention applications, elongation measured in accordance with JIS A 5759:2016 6.8 is 60% or greater, and the breaking strength is 50 N/25 mm or greater.

The decorative film of the present disclosure can be used in a vehicle and components thereof used indoor/outdoor, a building (inner/outer walls, pillars, windows, and the like), a traffic sign, a packaging material, a signage, an internally illuminated signage, and the like.

### EXAMPLES

In the following examples, specific embodiments of the present disclosure will be illustrated, but the present invention is not limited to these examples. All ‘part’ and ‘percent’ are based on mass unless otherwise specified. A numerical value essentially includes an error originated from a measurement principle and a measuring device. The numerical value is generally indicated by a significant digit that is rounded.

The raw materials and reagents used in producing the decorative film are shown in Table 1.

TABLE 1

| | | | | | Solid | |
|---|---|---|---|---|---|---|
| | | Tg | | | content | |
| | Composition or description¹⁾ | (° C.) | Mw | Solvent | (mass %) | Supplier |
| Polyurethane | NeoRezR (trade name) R650, | — | — | Water | 38 | DSM Coating |
| 1 (PU1) | water-based polyether | | | | | Resins |
| | polyurethane, non-yellowing, | | | | | (Zwolle, the |
| | thermoplastic | | | | | Netherlands) |
| Polyurethane | NeoRezR (trade name) R2005, | — | — | Water | 35 | DSM Coating |
| 2 (PU2) | blend of polyester | | | | | Resins |
| | polyurethane and polyacrylate | | | | | (Zwolle, the |
| | polymer, water-based, non- | | | | | Netherlands) |
| | yellowing, thermoplastic | | | | | |
| Polyurethane | ETERNACOLL (trade name) | — | — | Water | 30 | Ube Industries, Ltd. |
| 3 (PU3) | UW5002, water-based | | | | | (Minato-ku, Tokyo, |
| | polycarbonate polyurethane, | | | | | Japan) |
| | elastic modulus about 1200 | | | | | |
| | MPa | | | | | |
| Polyurethane | ETERNACOLL (trade name) | — | — | Water | 30 | Ube Industries, Ltd. |
| 4 (PU4) | UW3039E, water-based | | | | | (Minato-ku, Tokyo, |
| | polycarbonate polyurethane, | | | | | Japan) |
| | elastic modulus about 520 MPa | | | | | |
| Polyurethane | Thermoplastic polyester | — | — | — | — | Sheedom Co., Ltd. |
| 5 (PU5) | polyurethane elastomer film, | | | | | (Osaka-shi, Osaka, |
| | thickness 150 μm, non- | | | | | Japan) |
| | yellowing | | | | | |
| Pigment | AF White E-3D, pigment | — | — | Water | 64 | Dainichiseika Color |
| dispersion | water-based dispersion | | | | | & Chemicals Mfg. |
| (PD1) | | | | | | Co., Ltd. |
| | | | | | | (Chuo-ku, Tokyo, |
| | | | | | | Japan) |
| Pigment | AF Red E-6, pigment water- | — | — | Water | 32 | Dainichiseika Color |
| dispersion | based dispersion | | | | | & Chemicals Mfg. |
| (PD2) | | | | | | Co., Ltd. |
| | | | | | | (Chuo-ku, Tokyo, |
| | | | | | | Japan) |
| Pigment | AF Red E-17, pigment water- | — | — | Water | 35 | Dainichiseika Color |
| dispersion | based dispersion | | | | | & Chemicals Mfg. |
| (PD3) | | | | | | Co., Ltd. |
| | | | | | | (Chuo-ku, Tokyo, |
| | | | | | | Japan) |
| Pigment | EP-65 White, pigment water- | — | — | Water | 62 | Dainichiseika Color |
| dispersion | based dispersion | | | | | & Chemicals Mfg. |
| (PD4) | | | | | | Co., Ltd. |
| | | | | | | (Chuo-ku, Tokyo, |
| | | | | | | Japan) |
| Pigment | EP-720 RED 2B, pigment | — | — | Water | 35 | Dainichiseika Color |
| dispersion | water-based dispersion | | | | | & Chemicals Mfg. |
| (PD5) | | | | | | Co., Ltd. |
| | | | | | | (Chuo-ku, Tokyo, |
| | | | | | | Japan) |
| Pigment | EP-510 Black TR, pigment | — | — | Water | 39 | Dainichiseika Color |
| dispersion | water-based dispersion | | | | | & Chemicals Mfg. |
| (PD6) | | | | | | Co., Ltd. |
| | | | | | | (Chuo-ku, Tokyo, |
| | | | | | | Japan) |
| Pigment | LIOFAST (trade name) SF611 | — | — | Water | 73 | TOYOCOLOR CO., |
| dispersion | White, pigment water-based | | | | | LTD. |
| (PD7) | dispersion | | | | | (Chuo-ku, Tokyo, |
| | | | | | | Japan) |
| Pigment | LIOFAST (trade name) SF645 | — | — | Water | 36 | TOYOCOLOR CO., |
| dispersion | Red, pigment water-based | | | | | LTD. |
| (PD8) | dispersion | | | | | (Chuo-ku, Tokyo, |
| | | | | | | Japan) |
| Pigment | EMF (trade name) White HR, | — | — | Water | 74 | TOYOCOLOR CO., |
| dispersion | pigment water-based | | | | | LTD |
| (PD9) | dispersion | | | | | (Chuo-ku, Tokyo, |
| | | | | | | Japan) |
| Pigment | EMF (trade name) RED HFB, | — | — | Water | 37 | TOYOCOLOR CO., |
| dispersion | pigment water-based | | | | | LTD. |
| (PD10) | dispersion | | | | | (Chuo-ku, Tokyo, |
| | | | | | | Japan) |
| Pigment | EMF (trade name) ORANGE | — | — | Water | 37 | TOYOCOLOR CO., |
| dispersion | RL, pigment water-based | | | | | LTD. |
| (PD11) | dispersion | | | | | (Chuo-ku, Tokyo, |
| | | | | | | Japan) |
| Dispersant 1 | MMA-BMA- | 63 | 68000 | EtOAc | 40 | — |
| (D1) | DMAEMA = 60:34:6 | | | | | |
| Tacky | BA-2EHA-AN-AA = | −53 | 500000 | EtOAc | 33 | — |
| adhesive | 58:36:2:4 | | | | | |
| polymer 1 | | | | | | |
| (ADH1) | | | | | | |
| Tacky | 2EHA-BA-AA = 64:30:6 | −57 | 280000 | EtOAc | 60 | — |
| adhesive | | | | | | |
| polymer 2 | | | | | | |
| (ADH2) | | | | | | |
| Crosslinking | Bisamide-based, (1,1′- | — | — | Toluene | 5 | 3M Japan Ltd. |
| agent 1 | isophthaloyl-bis(2-methyl | | | | | (Shinagawa-ku, |
| (CL1) | aziridine) | | | | | Tokyo, Japan) |
| Crosslinking | Tetrad-X, polyfunctional liquid | — | — | — | 100 | Mitsubishi Gas |
| agent 2 | epoxy resin, N,N,N′,N′- | | | | | Chemical |
| (CL2) | tetraglycidyl-m-xylenediamine | | | | | Company, Inc. |
| | | | | | | (Chiyoda-ku, |
| | | | | | | Tokyo, Japan) |

¹⁾BA: n-butyl acrylate, AN: acrylonitrile, AA: acrylic acid, 2EHA: 2-ethylhexyl acrylate, EtOAc: ethyl acetate MMA: methylmethacrylate, BMA: n-butylmethacrylate, DMAEMA: 2-(dimethylamino)ethyl methacrylate

### Example 1

### Preparation of Transparent Surface Layer FL1

Polyurethane 3 (PU3) was applied onto a polyester film (support film) having a thickness of 50 μm using a knife coater, and dried at 95° C. for 5 minutes to form a transparent surface layer FL1 having a thickness of 30 μm.

### Preparation of Colored Polyurethane Layer

A mixer (TK Auto Homo Mixer, PRIMIX Corporation (Awaji-shi, Hyogo, Japan)) was used to mix polyurethane 1 (PU1) and polyurethane 2 (PU2), thereby preparing a premix. The mass ratio of PU1 and PU2 was 90:10 in terms of solid content. The solid content of the premix was about 30 mass %.

The premix and a pigment dispersion (PD1) were mixed using the mixer to prepare a colored polyurethane layer composition. The mass ratio of the premix and PD1 was 100:10 in terms of solid content.

The colored polyurethane layer composition was applied onto the transparent surface layer FL1 using a knife coater, and dried at 95° C. for 5 minutes to form a colored polyurethane layer having a thickness of 17 μm.

### Preparation of White Adhesive Layer

A premix including a white pigment (WP1, Ti-Pure (trade name) R960, The Chemours Company (Wilmington, Delaware, USA)), dispersant 1 (D1), and methyl ethyl ketone (MEK) was prepared. The mass ratio of WP1 and D1 was 5:1 in terms of solid content. The solid content of the premix was about 66 mass %.

The premix and the tacky adhesive polymer 1 (ADH1) were mixed. The mass ratio of ADH1, WP1, and D1 was 100:50:10 in terms of solid content. Crosslinking agent 1 (CL1) is mixed to the obtained mixture to prepare a white adhesive 1 (WA1). The mass ratio of ADH1 and CL1 was 100:0.2 in terms of solid content. The solid content of WA1 was about 35 mass %.

WA1 was applied onto a silicone-coated polyethylene laminate paper liner using a knife coater, and dried at 95° C. for 5 minutes to form a white adhesive layer having a thickness of 30 μm.

### Production of Decorative Film

The white adhesive layer was laminated on the colored polyurethane layer, and the support film was removed to produce the decorative film of Example 1.

### Examples 2 to 6

Decorative films of Examples 2 to 6 were produced by the same procedure as in Example 1 except that pigment dispersions shown in Table 2 were used instead of PD1.

### Example 7

### Preparation of Transparent Surface Layer FL2

Polyurethane 4 (PU4) was applied onto a polyester film (support film) having a thickness of 50 μm using a knife coater, and dried at 95° C. for 5 minutes to form a transparent surface layer FL2 having a thickness of 30 μm.

### Preparation of Colored Polyurethane Layer

A mixer (TK Auto Homo Mixer, PRIMIX Corporation (Awaji-shi, Hyogo, Japan)) was used to mix polyurethane 1 (PU1) and polyurethane 2 (PU2), thereby preparing a premix. The mass ratio of PU1 and PU2 was 90:10 in terms of solid content. The solid content of the premix was about 30 mass %.

The premix and the pigment dispersion (PD4) were mixed using the mixer to prepare a colored polyurethane layer composition. The mass ratio of the premix and PD4 was 100:10 in terms of solid content.

The colored polyurethane layer composition was applied onto the transparent surface layer FL2 using a knife coater, and dried at 95° C. for 5 minutes to form a colored polyurethane layer having a thickness of 22 μm.

### Preparation of White Adhesive Layer

The premix of Example 1 and the tacky adhesive polymer 2 (ADH2) were mixed. The mass ratio of ADH2, WP1, and D1 was 100:50:10 in terms of solid content. Crosslinking agent 2 (CL2) was mixed to the obtained mixture to prepare a white adhesive 2 (WA2). The mass ratio of ADH2 and CL2 was 100:0.23 in terms of solid content. The solid content of WA2 was about 58 mass %.

WA2 was applied onto a silicone-coated polyethylene laminate paper liner using a knife coater, and dried at 95° C. for 5 minutes to form a white adhesive layer having a thickness of 30 μm.

### Production of Decorative Film

The white adhesive layer was laminated on the colored polyurethane layer, and the support film was removed to produce a decorative film of Example 7.

### Examples 8 and 9

The decorative films of Example 8 and Example 9 were produced in the same procedure as in Example 7 except that the pigment dispersions shown in Table 2 were used instead of PD4.

### Comparative Example 1

A PVC-based 3M (trade name) Scotchcal (trade name) film JS1237XL was used.

### Comparative Example 2

A PVC-based 3M (trade name) Scotchcal (trade name) film JS1000XL was used.

### Examples 10 to 14

The decorative films of Examples 10 to 14 were produced in the same procedure as in Example 1 except that the pigment dispersions shown in Table 2 were used instead of PD1 and WA2 was used instead of WA1.

### Examples 15 and 16

### Preparation of Transparent Adhesive Layer

The tacky adhesive polymer 2 (ADH2) and the dispersion 1 (D1) were mixed. The mass ratio of ADH2 and D1 was 100:15 in terms of solid content. Crosslinking agent 2 (CL2) is mixed to the obtained mixture to prepare a transparent adhesive 1 (CA1). The mass ratio of ADH2 and CL2 was 100:0.2 in terms of solid content. The solid content of CA1 was about 50 mass %.

CA1 was applied onto a silicone-coated polyethylene laminate paper liner using a knife coater, and dried at 95° C. for 5 minutes to form a transparent adhesive layer having a thickness of 30 μm.

### Production of Decorative Film

The decorative films of Example 15 and Example 16 were produced in the same procedure as in Example 1 except that the pigment dispersions shown in Table 2 were used instead of PD1, and CA1 was used instead of WA1.

### Example 17

### Preparation of Colored Polyurethane Layer

Polyurethane 5 (PU) was used as the transparent surface layer FL3. A colored polyurethane layer was formed in the same procedure as in Example 1 except that PD5 was used instead of PD1 and FL3 was used instead of FL1.

### Preparation of White Adhesive Layer

A premix including a white pigment (WP1, Ti-Pure (trade name) R960, The Chemours Company (Wilmington, Delaware, USA)), dispersant 1 (D1), and methyl ethyl ketone (MEK) was prepared. The mass ratio of WP1 and D1 was 5:1 in terms of solid content. The solid content of the premix was about 66 mass %.

The premix and the tacky adhesive polymer 2 (ADH2) were mixed. The mass ratio of ADH2, WP1, and D1 was 100:50:10 in terms of solid content. Crosslinking agent 2 (CL2) was mixed to the obtained mixture to prepare a white adhesive 3 (WA3). The mass ratio of ADH2 and CL2 was 100:0.23 in terms of solid content. The solid content of WA3 was about 58 mass %.

WA3 was applied onto a silicone-coated polyethylene laminate paper liner using a knife coater, and dried at 95° C. for 5 minutes to form a white adhesive layer having a thickness of 30 μm.

### Production of Decorative Film

The white adhesive layer was laminated on the colored polyurethane layer, and the support film was removed to produce a decorative film of Example 17.

### Reference Example 1

3M (trade name) Scotchgard (trade name) paint protection film pro-series SGH6PRO4 was used.

### Reference Example 2

3M (trade name) High-Protection Film SJ6595JP was used.

### Comparative Example 3

A PVC-based 3M (trade name) Scotchcal (trade name) film JS1236XL was used.

### Comparative Example 4

A PVC-based 3M (trade name) Scotchcal (trade name) film JS6217XL was used.

### Yield Strength and Breaking Strength

A test piece was prepared by cutting a decorative film into a width of 25 mm and a length of 150 mm. Using a tensile tester (Tensilon universal testing machine, model: RTC-1210A, available from A&D Company, Limited (Toshima-ku, Tokyo, Japan)), the tensile strength at the yield point and the breaking point at 20° C. was measured under the condition at 20° C., the distance between grips of 100 mm, at the tensile speed of 300 mm/min.

### Elongation

A test piece was prepared by cutting a decorative film into a width of 25 mm and a length of 150 mm. Using a tensile tester (Tensilon universal testing machine, model: RTC-1210A, manufactured by A&D Company, Limited (Toshima-ku, Tokyo, Japan)), the elongation at 20° C. was measured under the condition at 20° C., the distance between grips of 100 mm, at the tensile speed of 300 mm/min. The elongation is defined by the following equation.

Elongation (%)=(length of test piece after test−length of test piece before test)/length of test piece before test

Tensile Strength at 2% Strain

A test piece was prepared by cutting a decorative film into a width of 25 mm and a length of 150 mm. Using a tensile tester (Tensilon universal testing machine, model: RTC-1210A, manufactured by A&D Company, Limited (Toshima-ku, Tokyo, Japan)), the tensile strength at 2% strain at 20° C. was measured under the condition at 20° C., the distance between grips of 100 mm, at the tensile speed of 300 mm/min.

### Adhesive Force 1

A test piece was prepared by cutting a decorative film into a width of 25 mm and a length of 150 mm. The test piece was adhered on a melamine-coated panel (Paltek Corporation (Hiratsuka-shi, Kanagawa, Japan)) at 20° C. using a roller. The adhering method was in accordance with JIS Z 0237:2009. The test piece was left at 20° C. for 48 hours. Using a tensile tester (Tensilon universal testing machine, model: RTC-1210A, manufactured by A&D Company, Limited (Toshima-ku, Tokyo, Japan)), the adhesive force at the time of performing 180 degree peeling was measured at a peeling rate of 300 mm/min at 20° C.

### Adhesive Force 2

A test piece was prepared by cutting a decorative film into a width of 25 mm and a length of 150 mm. The test piece was adhered on a melamine-coated panel (Paltek Corporation (Hiratsuka-shi, Kanagawa, Japan)) at 20° C. using a roller. The adhering method was in accordance with JIS Z 0237:2009. The test piece was left in an oven set to 65° C. for 7 days. Using a tensile tester (Tensilon universal testing machine, model: RTC-1210A, manufactured by A&D Company, Limited (Toshima-ku, Tokyo, Japan)), the adhesive force at the time of performing 180 degree peeling was measured at a peeling rate of 300 mm/min at 20° C.

### Removability

A test piece was prepared by cutting a decorative film into a width of 25 mm and a length of 150 mm. The test piece was adhered on a melamine-coated panel (Paltek Corporation (Hiratsuka-shi, Kanagawa, Japan)) at 20° C. using a roller. The test piece was left in an oven set to 65° C. for 7 days. Using a tensile tester (Tensilon universal testing machine, model: RTC-1210A, available from A&D Company, Limited (Toshima-ku, Tokyo, Japan)), 180 degree peeling was performed at a peeling rate of 300 mm/min at 20° C. A test piece for which no residue of the adhesive was observed on the melamine-coated panel was evaluated as A. A test piece for which a residue of the adhesive was partially observed on the melamine-coated panel was evaluated as B. A test piece for which a residue of the adhesive was observed on the entire melamine-coated panel was evaluated as C.

### Heat Shrinkage

A test piece was prepared by cutting a decorative film into a width of 50 mm and a length of 100 mm. The test piece was adhered on an aluminum panel A5052P (Paltek Corporation (Hiratsuka-shi, Kanagawa, Japan)) in an environment at 23° C. by a roller and left for 24 hours in an environment at 23° C. On the test piece, cut in shape of cross was made by a utility knife. The test piece was then heated at 65° C. for 48 hours. After the heat aging, the shrinkage (mm) of the film was measured by a microscope, and a maximum value was recorded.

### Non-Flammability Test

A decorative film was adhered on a zinc-plated steel plate (thickness: 0.27 mm). Test was conducted in accordance with ISO 5660-1 cone calorimeter heat release test. A heat release rate (kW/m²) and a total heat release (MJ/m²) were measured as parameters using a cone calorimeter (available from Toyo Seiki Seisaku-sho, Ltd.). When the total heat release for 20 minutes after start of heating was 8 MJ/m² or lower and the time indicating a heat release rate exceeding 200 kW/m² was 10 seconds or shorter in total, the decorative film was determined to pass, and otherwise the decorative film was determined to fail.

The details and evaluation results of Example 1 to Example 16 and Comparative Example 1 to Comparative Example 2 are shown in Table 2, and the details and evaluation results of Example 17, Reference Example 1 to Reference Example 2 and Comparative Example 3 to Comparative Example 4 are shown in Table 3.

TABLE 2

| | | | | Colored polyurethane layer | | | | | |
|---|---|---|---|---|---|---|---|---|---|
| | | Transparent | | Pigment | | | | | Decorative |
| | | surface layer | | dispersion | | | Adhesive layer | | film |
| | | | Thickness | | Part by | Thickness | | Thickness | Thickness |
| | Color | Type | (μm) | Type | mass*⁾ | (μm) | Type | (μm) | (μm) |
| Example 1 | White | FL1 | 30 | PD1 | 10 | 17 | WA1 | 30 | 77 |
| Example 2 | Red | FL1 | 30 | PD2 | 10 | 15 | WA1 | 30 | 75 |
| Example 3 | Red | FL1 | 30 | PD3 | 10 | 14 | WA1 | 30 | 74 |
| Example 4 | White | FL1 | 30 | PD4 | 10 | 17 | WA1 | 30 | 77 |
| Example 5 | Red | FL1 | 30 | PD5 | 10 | 15 | WA1 | 30 | 75 |
| Example 6 | Black | FL1 | 30 | PD6 | 10 | 14 | WA1 | 30 | 74 |
| Example 7 | White | FL2 | 30 | PD4 | 10 | 22 | WA2 | 30 | 82 |
| Example 8 | Red | FL2 | 30 | PD5 | 10 | 22 | WA2 | 30 | 82 |
| Example 9 | Black | FL2 | 30 | PD6 | 10 | 23 | WA2 | 30 | 83 |
| Comparative | Red | — | — | — | — | — | — | — | 83 |
| Example 1 | | | | | | | | | |
| Comparative | White | — | — | — | — | — | — | — | 83 |
| Example 2 | | | | | | | | | |
| Example | White | FL1 | 30 | PD7 | 10 | 20 | WA2 | 30 | 80 |
| 10 | | | | | | | | | |
| Example | Red | FL1 | 30 | PD8 | 10 | 15 | WA2 | 30 | 75 |
| 11 | | | | | | | | | |
| Example | White | FL1 | 30 | PD9 | 10 | 17 | WA2 | 30 | 77 |
| 12 | | | | | | | | | |
| Example | Red | FL1 | 30 | PD10 | 10 | 21 | WA2 | 30 | 81 |
| 13 | | | | | | | | | |
| Example | Orange | FL1 | 30 | PD11 | 10 | 20 | WA2 | 30 | 80 |
| 14 | | | | | | | | | |
| Example | Red | FL1 | 30 | PD8 | 2 | 15 | CA1 | 30 | 75 |
| 15 | | | | | | | | | |
| Example | Red | FL1 | 30 | PD10 | 2 | 18 | CA1 | 30 | 78 |
| 16 | | | | | | | | | |

| | Yield | Breaking | | Tensile | Adhesive | Adhesive | | | |
|---|---|---|---|---|---|---|---|---|---|
| | strength | strength | | strength at | force 1 | force 2 | | | |
| | (N/25 | (N/25 | Elongation | 2% strain | (N/25 | (N/25 | | Heat | Non- |
| | mm) | mm) | (%) | (N/25 mm) | mm) | mm) | Removability | Shrinkage | flammability |
| Example 1 | 47 | 48 | 83 | 24 | 5 | 16 | A | 0.14 | Pass |
| Example 2 | 46 | 59 | 143 | 22 | 5 | 15 | A | 0.12 | Pass |
| Example 3 | 46 | 49 | 92 | 23 | 5 | 15 | A | 0.12 | Pass |
| Example 4 | 46 | 59 | 143 | 24 | 5 | 15 | A | 0.12 | Pass |
| Example 5 | 43 | 48 | 116 | 23 | 4 | 14 | A | 0.11 | Pass |
| Example 6 | 24 | 47 | 88 | 23 | 4 | 15 | A | 0.11 | Pass |
| Example 7 | 19 | 40 | 116 | 9 | 12 | 25 | A | 0.22 | Pass |
| Example 8 | 17 | 50 | 185 | 8 | 10 | 25 | A | 0.20 | Pass |
| Example 9 | 18 | 67 | 225 | 9 | 9 | 24 | A | 0.22 | Pass |
| Comparative | 30 | 44 | 222 | 19 | 29 | 34 | B | 0.60 | Pass |
| Example 1 | | | | | | | | | |
| Comparative | 45 | 38 | 13 | 31 | 23 | 28 | B | 0.24 | Pass |
| Example 2 | | | | | | | | | |
| Example | 42 | 48 | 135 | 22 | 10 | 26 | A | 0.20 | Pass |
| 10 | | | | | | | | | |
| Example | 41 | 51 | 141 | 21 | 10 | 24 | A | 0.18 | Pass |
| 11 | | | | | | | | | |
| Example | 40 | 53 | 152 | 21 | 9 | 21 | A | 0.18 | Pass |
| 12 | | | | | | | | | |
| Example | 44 | 53 | 140 | 22 | 10 | 25 | A | 0.21 | Pass |
| 13 | | | | | | | | | |
| Example | 43 | 50 | 134 | 21 | 7 | 22 | A | 0.20 | Pass |
| 14 | | | | | | | | | |
| Example | 41 | 42 | 120 | 17 | ND | ND | ND | ND | Pass |
| 15 | | | | | | | | | |
| Example | 43 | 51 | 137 | 20 | ND | ND | ND | ND | Pass |
| 16 | | | | | | | | | |

*⁾Value for 100 parts by mass of premix in terms of solid content

TABLE 3

| | | | | Colored polyurethane layer | | | | | |
|---|---|---|---|---|---|---|---|---|---|
| | | Transparent | | Pigment | | | | | Decorative |
| | | surface layer | | dispersion | | | Adhesive layer | | film |
| | | | Thickness | | Part by | Thickness | | Thickness | Thickness |
| | Color | Type | (μm) | Type | mass*⁾ | (μm) | Type | (μm) | (μm) |
| Example 17 | Red | FL3 | 150 | PD5 | 10 | 17 | WA3 | 30 | 197 |
| Reference | Transparent | — | — | — | — | — | — | — | 200 |
| Example 1 | | | | | | | | | |
| Reference | Transparent | — | — | — | — | — | — | — | 200 |
| Example 2 | | | | | | | | | |
| Comparative | Red | — | — | — | — | — | — | — | 83 |
| Example 3 | | | | | | | | | |
| Comparative | Red | — | — | — | — | — | — | — | 113 |
| Example 4 | | | | | | | | | |

| | | | Tensile | | | | |
|---|---|---|---|---|---|---|---|
| | Breaking | | strength at | Adhesive | Adhesive | | |
| | strength | Elongation | 2% strain | force 1 | force 2 | | Heat |
| | (N/25 mm) | (%) | (N/25 mm) | (N/25 mm) | (N/25 mm) | Removability | Shrinkage |
| Example 17 | >141 | >300 | 3 | 8 | 23 | B | 0.08 |
| Reference | 83 | 226 | 8 | 13 | 32 | A | 0.14 |
| Example 1 | | | | | | | |
| Reference | >74 | >300 | 7 | 18 | 32 | B | 0.13 |
| Example 2 | | | | | | | |
| Comparative | 39 | 189 | 24 | 31 | 34 | C | 0.68 |
| Example 3 | | | | | | | |
| Comparative | 60 | 205 | 32 | 29 | 29 | C | 0.20 |
| Example 4 | | | | | | | |

*⁾Value for 100 parts by mass of premix in terms of solid content

Various variations of the above-mentioned embodiments and examples will be apparent to those skilled in the art without departing from the basic principle of the present invention. In addition, it is apparent for a person skilled in the art that various modifications and variations of the present invention can be made without departing from the spirit and scope of the present invention. Some of the embodiments of the present disclosure are described below.

### First Aspect

A decorative film including a transparent surface layer, a colored polyurethane layer, and an adhesive layer,
wherein the colored polyurethane layer includes a water-based polyether-based polyurethane and a pigment, and
the transparent surface layer and the colored polyurethane layer are disposed adjacent to each other.

### Second Aspect

The decorative film according to the first aspect, wherein the transparent surface layer includes a polyurethane.

### Third Aspect

The decorative film according to the second aspect, wherein the polyurethane included in the transparent surface layer is a polycarbonate-based polyurethane.

### Fourth Aspect

The decorative film according to the third aspect, having a tensile strength at 2% strain of 2 N/25 mm or greater, and an elongation of 30% or greater.

### Fifth Aspect

The decorative film according to the second aspect, wherein the polyurethane included in the transparent surface layer is a non-yellowing thermoplastic polyurethane elastomer.

### Sixth Aspect

The decorative film according to the fifth aspect, having a tensile strength at 2% strain of 20 N/25 mm or less, and an elongation of 120% or greater.

### Seventh Aspect

The decorative film according to any one of the first to sixth aspects, wherein the colored polyurethane layer further includes a water-based polyester-based polyurethane and a polyacrylate.

### Eighth Aspect

The decorative film according to any one of the first to seventh aspects, wherein the pigment included in the colored polyurethane layer includes titanium oxide.

### Ninth Aspect

The decorative film according to any one of the first to eighth aspects, wherein a total heat release for 20 minutes after start of heating as measured in accordance with ISO 5660-1 Heat Release Rate (cone calorimeter method) is 8 MJ/m² or less.

### Tenth Aspect

The decorative film according to any one of the first to ninth aspects, wherein the adhesive layer contains a carboxy group-containing (meth)acrylic polymer, an amino group-containing (meth)acrylic polymer, and 5 mass % to 50 mass % of titanium oxide.

### REFERENCE SIGNS LIST

10 Decorative film
12 Transparent surface layer
14 Colored polyurethane layer
16 Adhesive layer
18 Release liner

1. A decorative film comprising: a transparent surface layer; a colored polyurethane layer; and an adhesive layer,
wherein the colored polyurethane layer includes a water-based polyether-based polyurethane and a pigment, and
the transparent surface layer and the colored polyurethane layer are disposed adjacent to each other.

2. The decorative film according to claim 1, wherein the transparent surface layer includes a polyurethane.

3. The decorative film according to claim 2, wherein the polyurethane included in the transparent surface layer is a polycarbonate-based polyurethane.

4. The decorative film according to claim 3, having a tensile strength at 2% strain of 2 N/25 mm or greater, and an elongation of 30% or greater.

5. The decorative film according to claim 2, wherein the polyurethane included in the transparent surface layer is a non-yellowing thermoplastic polyurethane elastomer.

6. The decorative film according to claim 5, having a tensile strength at 2% strain of 20 N/25 mm or less, and an elongation of 120% or greater.

7. The decorative film according to claim 1, wherein the colored polyurethane layer further includes a water-based polyester-based polyurethane and a polyacrylate.

8. The decorative film according to claim 1, wherein the pigment included in the colored polyurethane layer includes titanium oxide.

9. The decorative film according to claim 1, wherein a total heat release for 20 minutes after start of heating as measured in accordance with ISO 5660-1 Heat Release Rate (cone calorimeter method) is 8 MJ/m² or less.

10. The decorative film according to claim 1, wherein the adhesive layer contains a carboxy group-containing (meth)acrylic polymer, an amino group-containing (meth)acrylic polymer, and 5 mass % to 50 mass % of titanium oxide.
